(19) United States
(12) Patent Application Publication
(10) Pub. No.: US 2015/0155898 A1
(43) Pub. Date: Jun. 4, 2015

(54) METHODS AND SYSTEMS FOR CALIBRATING AN ANALOG FILTER

(71) Applicant: Marvell World Trade Ltd., St. Michael (BB)

(72) Inventors: Srinivas PINAGAPANY, San Jose, CA (US); Sergey TIMOFEEV, Mountain View, CA (US); Atul SALHOTRA, Santa Clara, CA (US)

(73) Assignee: Marvell World Trade Ltd., St. Michael (BB)

(21) Appl. No.: 14/560,827

(22) Filed: Dec. 4, 2014

Related U.S. Application Data
(60) Provisional application No. 61/911,740, filed on Dec. 4, 2013.

(51) Int. Cl. H04B 1/12; H04B 17/00

(52) U.S. Cl. CPC H04B 1/123; H04B 17/0062

(57) ABSTRACT

Devices and methods capable of addressing filter responses are disclosed. For example, a method for compensating a first low-pass filter and a second low-pass filter is disclosed. The method includes injecting a reference tone f_{R} and a cutoff tone f_{C} into the first low-pass filter, and measuring respective filter responses of the reference tone f_{R} and the cutoff tone f_{C} while changing capacitor codes that control a cutoff frequency of the first low-pass filter until a first capacitor code I_{CODE} is determined that most accurately causes the first low-pass filter to utilize a desired cutoff frequency f₀, performing a similar operation for the second low-pass filter until a second capacitor code Q_{CODE} is determined, and calibrating for mismatch between the first low-pass filter and the second low-pass filter.

### INCORPORATION BY REFERENCE

This application claims the benefit of U.S. Provisional Application No. 61/911,740 entitled “Analog Filter Calibration” filed on Dec. 4, 2013, the content of which is incorporated herein by reference in its entirety.

### BACKGROUND

Wireless communication devices, such as cellular telephones, contain sophisticated integrated electronics used to receive and transmit wireless data. Unfortunately, the analog electronics of such integrated electronics is subject to process variation from one wafer to the next. This can result in characteristics of various components—e.g., resistor values and capacitor values—varying to the point that it may be impossible to use a particular device without some form of individualized device compensation. The issue of component variation can even extend to devices within a single chip. Thus, even two identically-designed devices in a single chip can and do exhibit substantial mismatch. This problem tends to increase in severity as integrated circuit geometries continue to shrink.

### SUMMARY

Various aspects and embodiments of the invention are described in further detail below.

In an embodiment, a method for compensating for non-idealities in a filter circuit that includes programmable filter circuitry including a first low-pass filter and a second low-pass filter both having a common desired cutoff frequency f₀ is disclosed. The method includes, for a first desired bandwidth BW₀ corresponding to the common desired cutoff frequency f₀, injecting a reference tone f_{R} and a cutoff tone f_{C} into the first low-pass filter, and measuring respective filter responses of the reference tone f_{R} and the cutoff tone f_{C} while changing capacitor codes that control a cutoff frequency f_{0-I} of the first low-pass filter until a first capacitor code I_{CODE} is determined that most accurately causes the first low-pass filter to utilize the desired cutoff frequency f₀; for the first desired bandwidth BW₀, injecting the reference tone f_{R} and the cutoff tone f_{C} into the second low-pass filter, and measuring respective filter responses of the reference tone f_{R} and the cutoff tone f_{C} while changing capacitor codes that control a cutoff frequency f_{0-Q} of the second low-pass filter until a second capacitor code Q_{CODE} is determined that most accurately causes the second low-pass filter to utilize the desired cutoff frequency f₀; and further calibrating for mismatch between the first low-pass filter and the second low-pass filter for one or more additional bandwidths greater than the first desired bandwidth BW₀.

In another embodiment, a device for compensating for non-idealities in a filter circuit that includes programmable filter circuitry including a first low-pass filter and a second low-pass filter both having a common desired cutoff frequency f₀ corresponding to a first desired bandwidth BW₀ is disclosed. The device includes code search circuitry that controls the first low-pass filter and the second low-pass filter; tone generation circuitry that injects a reference tone f_{R} and a cutoff tone f_{C} into both the first low-pass filter and the second low-pass filter; measurement circuitry that: (1) measures respective filter responses of the reference tone f_{R} and the cutoff tone f_{C} while the code search circuitry changes capacitor codes that control a cutoff frequency f_{0-I} of the first low-pass filter until a first capacitor code I_{CODE} is determined that most accurately causes the first low-pass filter to utilize the desired cutoff frequency f₀; and (2) measures respective filter responses of the reference tone f_{R} and the cutoff tone f_{C} while the code search circuitry changes capacitor codes that control a cutoff frequency f_{0-Q} of the second low-pass filter until a second capacitor code Q_{CODE} is determined that most accurately causes the second low-pass filter to utilize the desired cutoff frequency f₀; and calibration circuitry configured to calibrate for mismatch between the first low-pass filter and the second low-pass filter for one or more additional bandwidths greater than a first desired bandwidth BW₀ of the desired cutoff frequency f₀.

### BRIEF DESCRIPTION OF THE DRAWINGS

Various embodiments of this disclosure that are proposed as examples will be described in detail with reference to the following figures, wherein like numerals reference like elements.

FIG. 1 is a block diagram of an example wireless communications device capable of transmitting and receiving wireless signals.

FIG. 2 depicts a block diagram of the down-converter of FIG. 1.

FIG. 3 depicts the wireless communications device of FIG. 1 reconfigured so as to be capable of self-calibration.

FIG. 4 is a power response of an example low-pass filter used in the wireless communications device of FIG. 1.

FIG. 5 depicts examples of phase mismatch that can occur between to identically-designed low-pass filters as a function of capacitor codes.

FIGS. 6A and 6B depict examples of how mismatch for low-pass filters for a particular bandwidth becomes worse at higher bandwidths.

FIG. 7 is a flowchart outlining a set of example operations for providing compensating for mismatched low-pass filters.

### DETAILED DESCRIPTION OF EMBODIMENTS

The disclosed methods and systems below may be described generally, as well as in terms of specific examples and/or specific embodiments. For instances where references are made to detailed examples and/or embodiments, it is noted that any of the underlying principles described are not to be limited to a single embodiment, but may be expanded for use with any of the other methods and systems described herein as will be understood by one of ordinary skill in the art unless otherwise stated specifically.

One of the most significant disadvantages of modern telecommunications equipment is that process variations for integrated circuits will cause analog components to vary not just between different wafers, but even for different devices on a single chip. Thus, two identically-designed low-pass filters on a single chip can be expected to have different cutoff frequencies. These differences can be problematic. For example, modern Orthogonal Frequency Division Modulation (OFDM) systems require a pair of matched low-pass filters in their RF-to-baseband and baseband-to-RF conversion circuitry, and even small amounts of mismatch can cause an OFDM device to operate poorly and outside of an industry specification.

To address these component variations, designers often incorporate some form of calibration circuitry so that individual filters can be adjusted to better conform with device specifications. Analog low-pass filters, for example, may contain banks of capacitors that can be programmably placed in and out of circuit such that a cutoff frequency may be fine-tuned.

Unfortunately, because calibration processes cannot exactly match every pair of low-pass filters due to practical circuit limitations, filter mismatch will occur not just under the conditions for which the calibration took place, but will likely be worse for other conditions that the filters must address. For example, assuming that two digital filters are calibrated using a bandwidth of 20 MHz, amplitude and phase variations between the two filters will increase for bandwidths of 40 MHz, and increase more for bandwidths of 80 MHz. Part of these increasing variations is caused by non-ideal components within analog filters, and part is due to the fact that the analog filters will need to be reprogrammed to address different cutoff frequencies as a function of bandwidth. By way of example, a analog low-pass filter for an OFDM communication system operating for a bandwidth of 20 MHz will require an 8.75 MHz cutoff frequency while an 18.75 MHz cutoff frequency will be needed for a 40 MHz bandwidth, and a 38.75 MHz cutoff frequency will be needed for an 80 MHz bandwidth.

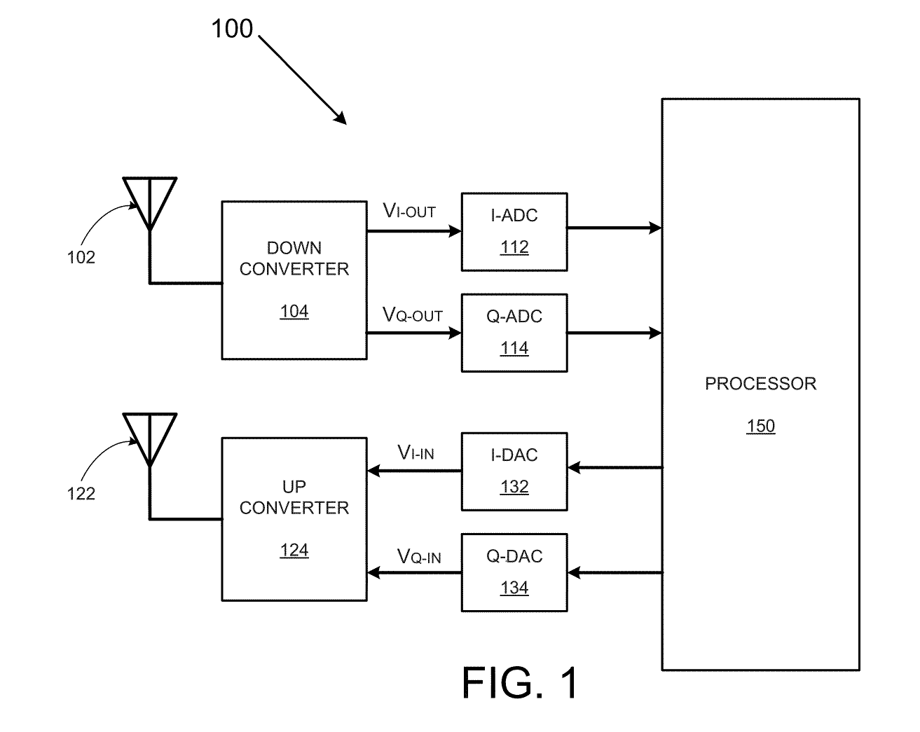

FIG. 1 is a block diagram of an example wireless communications device 100 capable of transmitting and receiving wireless signals. As shown in FIG. 1, the wireless communications device 100 includes a receive antenna 102, a down-converter 104, a first (I Channel) Analog-To-Digital Converter (I-ADC) 112, a second (Q Channel) Analog-To-Digital Converter (Q-ADC) 114, a transmit antenna 122, an up-converter 124, a first (I Channel) Digital-To-Analog Converter (I-DAC) 132, a second (Q Channel) Digital-To-Analog Converter (Q-DAC) 134, and a processor 150. As the operations of the various components 102-150 of FIG. 1 are well understood, a detailed description of their operation under normal communications will be omitted.

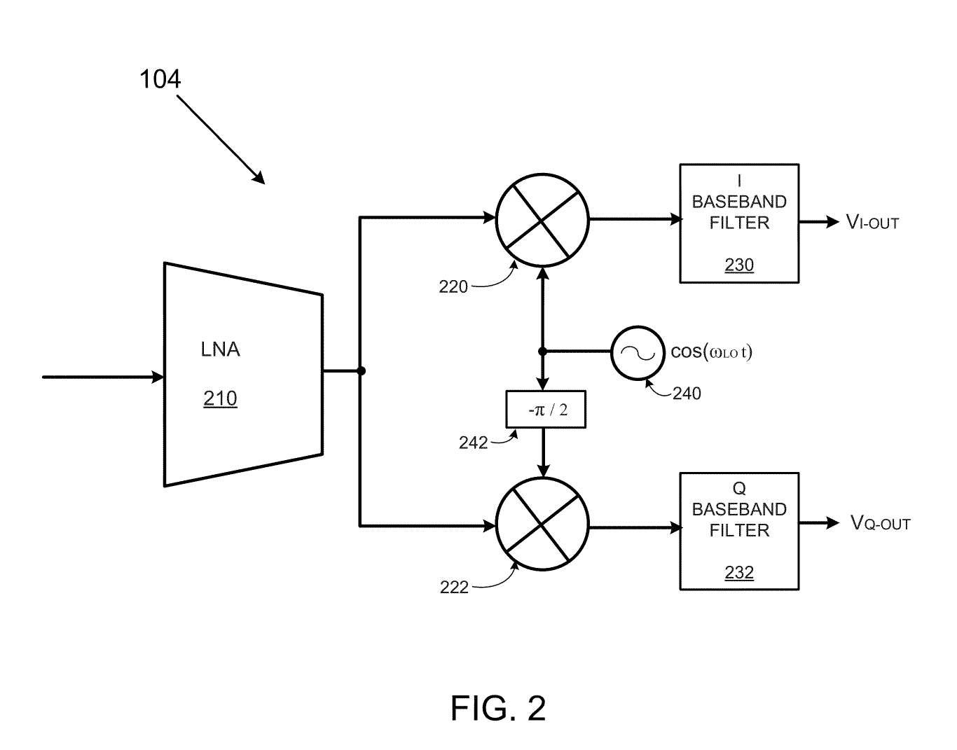

FIG. 2 depicts a block diagram of the down-converter 104 of FIG. 1. As shown in FIG. 2, the down-converter 104 includes a low-noise amplifier (LNA) 210, a first mixer 220, an I-baseband filter 230, a second mixer 222, a Q-baseband filter 232, a local oscillator (LO) 240 capable of producing a local oscillation signal cos(ω_{LO} t), where ω_{LO} is the local oscillation frequency, and a phase shift device 242 capable of shifting the local oscillation signal cos(ω_{LO} t) by −π/2 radians. As with FIG. 1, because the operations of the various components 210-232 are well understood, a detailed description of their operation under normal communications will be omitted. However, it is to be appreciated that, because wireless communication devices are often limited to only transmitting or receiving at any given point in time, most if not all of the various components 210-232 can be used for the up-converter 124 of FIG. 1 without detriment. Such an arrangement has a further advantage in that only a single pair of low-pass filters will need to be calibrated.

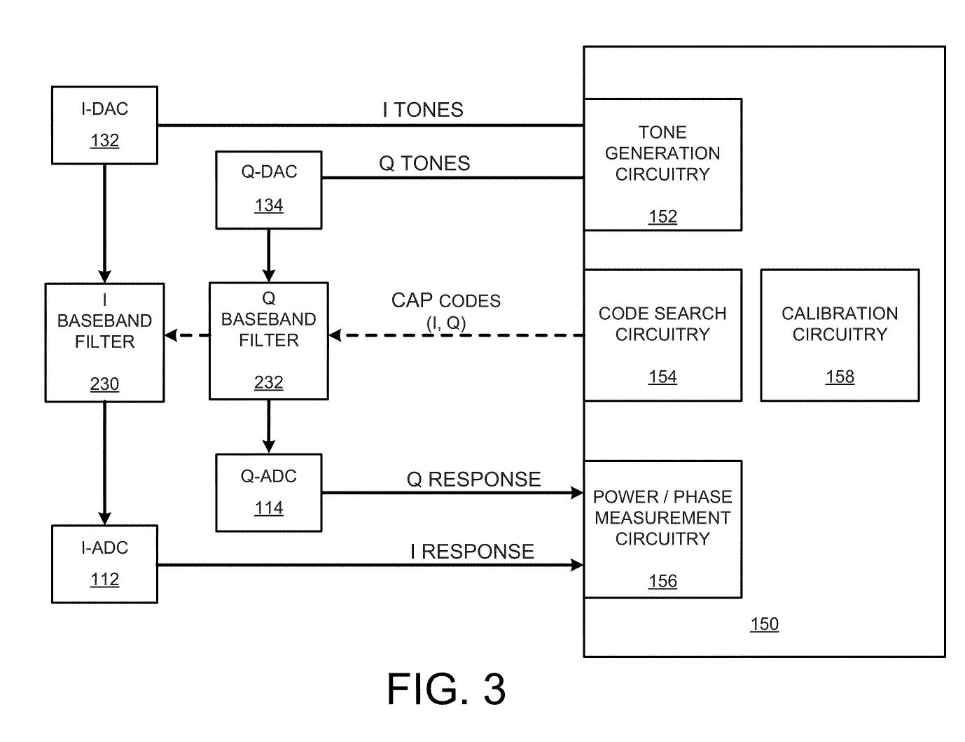

FIG. 3 depicts the wireless communications device 100 of FIG. 1 reconfigured so as to be capable of self-calibration. Also shown in FIG. 3, functional components of the processor 150 dedicated to filter calibration are displayed. Such functional components include tone generation circuitry 152, code search circuitry 154, power/phase measurement circuitry 156 and calibration circuitry 158. In various embodiments, the embedded circuitries 152-158 may individually be made from dedicated logic, may exists as software/firmware routines located in a tangible, non-transitory memory and operated upon by one or more processors, or exist as combinations of software/firmware processors and dedicated logic.

In operation, each of the I-baseband (low-pass) filter 230 and the Q-baseband (low-pass) filter 232 are calibrated such that each will, to a practical extent possible, have a common desired cutoff frequency f₀ corresponding to a first desired bandwidth BW₀. While there is no limitation as to the particular bandwidths or cutoff frequencies that may be used, for the purposes of explanation the first desired bandwidth BW₀ is 20 MHz, and the corresponding desired cutoff frequency f₀ is 8.75 MHz. Similarly, while there is no limitation as to the types of low-pass filters that may be used, for the purposes of explanation and practical example, the I-baseband filter 230 and Q-baseband filter 230 are both fifth-order Chebyshev Type-1 filters using switch-capacitor technology.

Initial calibration starts with the tone generation circuitry 152 (via the I-DAC 132 and the Q-DAC 134) injecting both a reference tone f_{R} and a cutoff tone f_{C} into each of the I-baseband filter 230 and the Q-baseband filter 232. The I-baseband filter 230 and the Q-baseband filter 232, in turn, provide a respective output response consistent with their respective non-ideal cutoff frequencies, f_{0-I} and f_{0-Q}, while the power/phase measurement circuitry 156 (via the I-ADC 112 and the Q-ADC 114) measures the respective filter responses.

During this time, the code search circuitry 154 will vary separate digital control codes (“capacitor codes” or “cap codes”) to the I-baseband filter 230 and the Q-baseband filter 232 until the respective non-ideal cutoff frequencies, f_{0-I} and f_{0-Q}, match the ideal cutoff frequency f₀ as close as possible given the available resolution of the capacitor codes. For example, assuming that the I-baseband filter 230 and the Q-baseband filter 232 each have a capacitor code resolution of 8 bits, the code search circuitry 154 can provide any number of search algorithms to provide capacitor codes within a range of [−128 to 127] until respective particular capacitor codes are selected that most accurately causes the baseband filters {230, 232} to utilize the desired cutoff frequency f₀. These selected capacitor codes will be referred to below as the first capacitor code I_{CODE} and the second capacitor code Q_{CODE}.

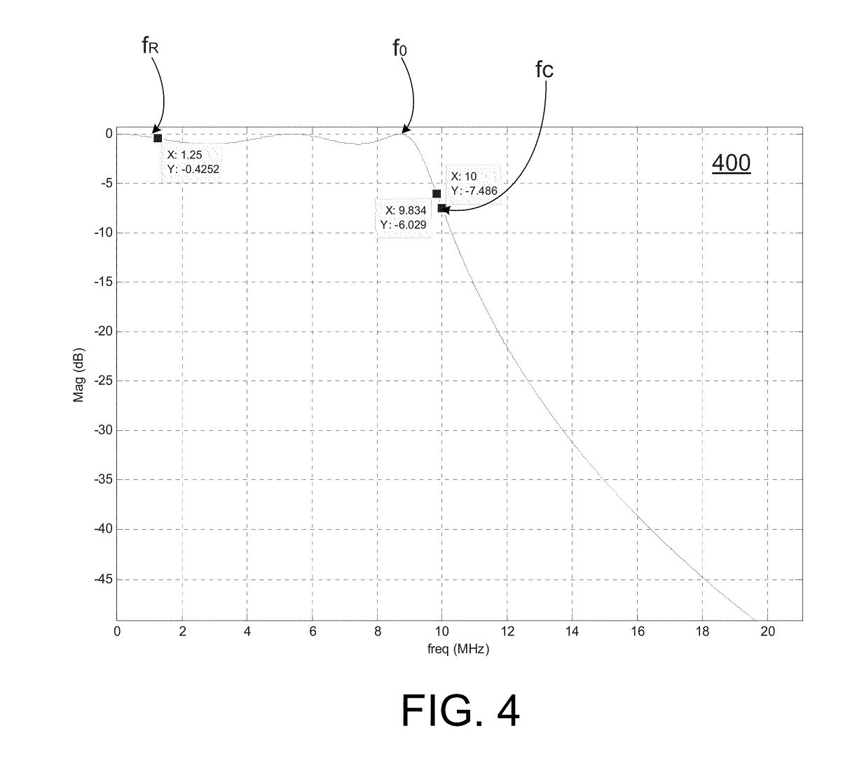

FIG. 4 is a power response 400 of an example low-pass filter useable in the wireless communications device of FIG. 1 and useful to explain how the reference tone f_{R} and the cutoff tone f_{C} may be used to select an appropriate capacitor code and utilize an appropriate cutoff frequency. As shown in FIG. 4, the power response 400 is atypical of a fifth-order Type-1 Chebyshev filter. The reference tone f_{R}, which is well within the pass-band region, is assigned a value of 1.25 MHz, and the cutoff tone f_{C} is assigned a value of 10 MHz. The power ratio of the responses for the reference tone f_{R} and the cutoff tone f_{C} will vary as a function of the cutoff frequency f₀ so as become larger as the cutoff frequency f₀ decreases, and become smaller as the cutoff frequency f_{C} increases. The power ratio for an ideal cutoff frequency f₀ of 8.75 MHz can be precisely determined, and a capacitor code can be adjusted until the power response 400 best reflects a known, predictable power ratio for the filter responses of the reference tone f_{R} and the cutoff tone f_{C}.

Returning to FIG. 3, once the appropriate capacitor codes {I_{CODE}, Q_{CODE}} are selected, the calibration circuitry 158 performs further calculations so as to better calibrate the I-baseband filter 230 and the Q-baseband filter 232 to compensate for filter mismatch for one or more additional bandwidths greater than bandwidth BW₀.

Typically, the one or more additional bandwidths will be a multiple of BW₀. For example, in various embodiments, a second desired bandwidth BW₁ will equal N×BW₀, where N is a positive integer greater than 1.

While bandwidths may be multiples of one another, respective cutoff frequencies for such larger bandwidths will not be multiples of one another. For instance, assuming BW₀=20 MHz and f₀=8.75 MHz, a second bandwidth BW₁ of 40 MHz will use a respective cutoff frequency f₁ of 18.75 MHz, which represents a “cutoff frequency offset” Δf of 1.25 MHz (18.75 MHz−(2*8.75 MHz)=1.25 MHz). Similarly, again assuming BW₀=20 MHz and f₀=8.75 MHz, a second bandwidth BW₁ of 80 MHz will use a respective cutoff frequency f₁ of 38.75 MHz, which represents a cutoff frequency offset Δf of 3.75 MHz (38.75 MHz MHz−(4*8.75 MHz)=3.75 MHz).

Although employing a cutoff frequency offset can be highly advantageous, such offsets are problematic in that the offsets may cause mismatch between a pair of low-pass filters at BW₁ to increase to a point where the increased mismatch causes a wireless device to fall outside of performance specifications. Accordingly, the calibration circuitry 158 is configured to, for a respective second cutoff frequency f₁ for a second/higher bandwidth BW₁, determine a capacitor code offsets ΔI_{OFFSET} and ΔQ_{OFFSET} commensurate with the frequency offset Δf, add the capacitor code offset ΔI_{OFFSET} to the first capacitor code I_{CODE} to produce a first compensated capacitor code I_{C-CODE}, and add the capacitor code offset ΔQ_{OFFSET} to the second capacitor code Q_{CODE} to produce a second compensated capacitor code Q_{C-CODE}.

However, the capacitor code offsets must not just reflect the frequency offset Δf, but must also take into consideration a “fractional capacitor code” CI_{FRAC} corresponding to the first desired bandwidth BW₀, the fractional capacitor code CI_{FRAC} being a value that lies between two consecutive capacitor codes [I_{CODE}, I_{CODE+1}] on I rail, keeping Qcode unchanged, and that ideally corresponds to both a zero phase difference and a zero power difference between a first low-pass filter and a second low-pass filter.

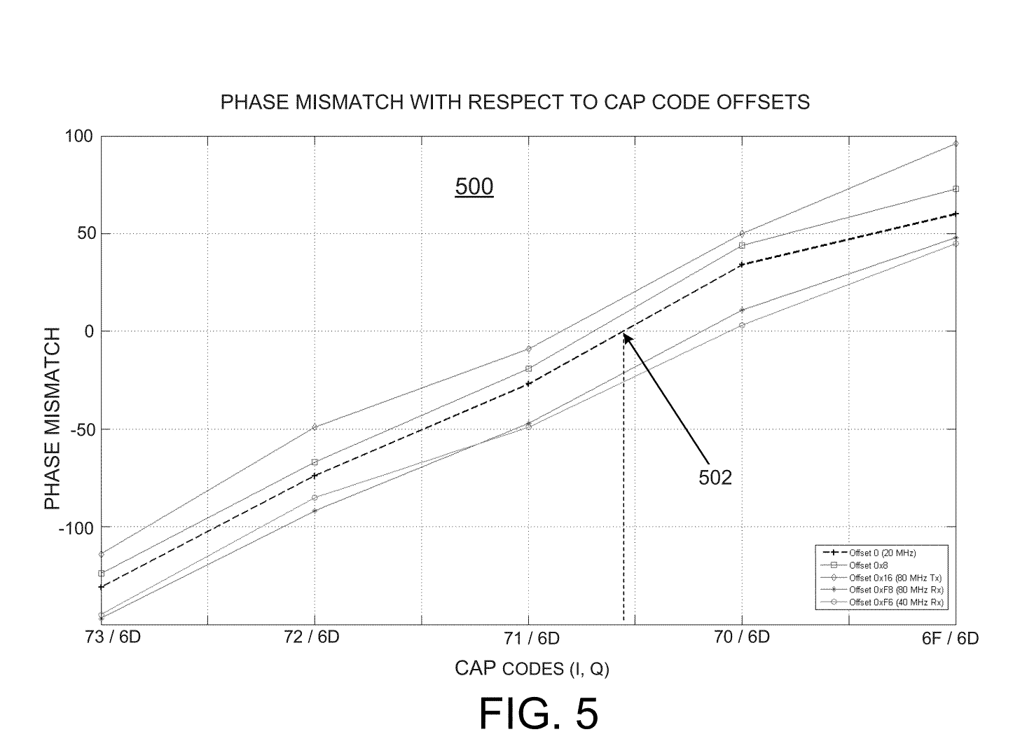

FIG. 5 depicts a chart 500 showing examples of phase mismatch that can occur between two identically-designed low-pass filters as a function of capacitor codes and capacitor code offsets ΔI_{OFFSET}/ΔQ_{OFFSET} to be used for other bandwidths. As shown in FIG. 5, five example responses are provided representing different capacitor code offsets ΔI_{OFFSET}/ΔQ_{OFFSET}, with the center (dotted) line representing a capacitor code offset ΔI_{OFFSET}/ΔQ_{OFFSET}=0. The X-axis is a dimension being a combined I-Q capacitor code [I_{CODE}, Q_{CODE}], and the Y-axis is a second dimension representing respective measured phase offsets between a first low-pass filter and a second low-pass filter as a function of the respective combined I-Q capacitor codes. The point 502 at which the dotted line displays zero phase mismatch occurs about half-way between I-Q capacitor code [71,6D] (signed hexadecimal notation representing a difference of 4) and I-Q capacitor code [70,6D] (signed hexadecimal notation representing a difference of 3).

The fractional capacitor code CI_{FRAC} will be a real, non-integer, number, and as such is incompatible with programmable filter circuitry that relies on discrete switches to program/calibrate. As such, the capacitor code offset ΔI_{OFFSET}/ΔQ_{OFFSET} may be determined by rounding the fractional capacitor code CI_{FRAC} to a nearest integer, adding the capacitor code offset ΔI_{OFFSET} to the first capacitor code I_{CODE} to produce the first compensated capacitor code I_{C-CODE}, and adding the capacitor code offset ΔQ_{OFFSET} to the second capacitor code Q_{CODE} to produce the second compensated capacitor code Q_{C-CODE}.

In various embodiments, the capacitor code offsets ΔI_{OFFSET} and ΔQ_{OFFSET} are calculated by rounding to the nearest integer the formula [(1+α Δfc) * ΔC_{FRAC}], where ΔC_{FRAC} is a difference between the fractional first capacitor code CI_{FRAC} and the second capacitor code Q_{CODE}, α is a scaling factor derived from empirical data, and Δfc is a capacitor code difference corresponding to the cutoff frequency offsets ΔI_{OFFSET} and ΔQ_{OFFSET}. If Δfc=0, then the capacitor code offset calculation is reduced to rounding to the nearest integer the formula [ΔC_{FRAC}]. However, assuming Δfc≠0, scaling factor α must be factored.

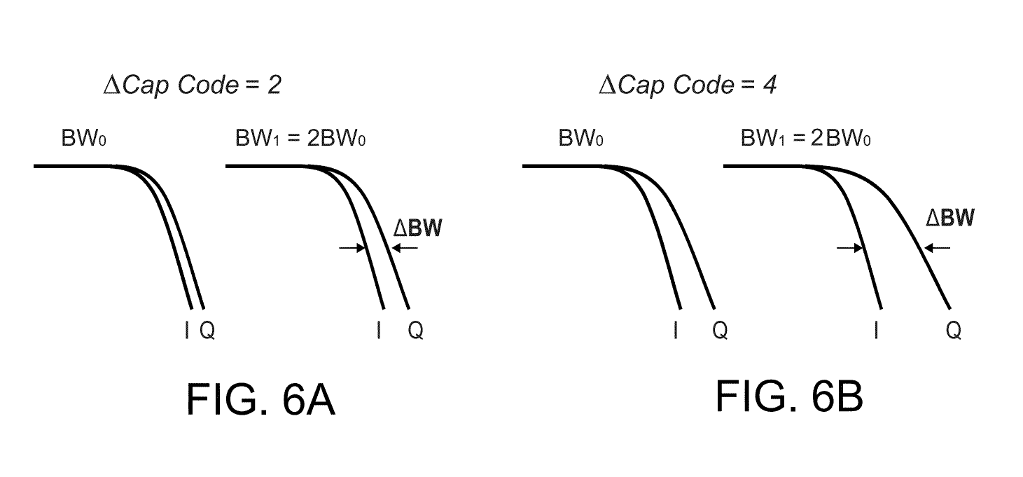

While a scaling factor α may be determined in a number of ways, in a number of embodiments a scaling factor α is determined based on empirical data. FIGS. 6A and 6B depict examples of how mismatch for low-pass filters for a particular bandwidth becomes worse at higher bandwidths. While FIGS. 6A and 6B are exemplary, conceptually they are based on real-world experience so as to demonstrate that filter mismatch will increase as a function of Δfc and the magnitude of BW₁. An appropriate scaling factor α will reflect desired compensation for different Δfc and different magnitudes of BW₁.

Again returning to FIG. 3, once the calibration circuitry 158 has determined the first compensated capacitor code I_{C-CODE} and the second compensated capacitor code Q_{C-CODE}, the processor 150 applies the first compensated capacitor code I_{C-CODE} to the first/I-baseband (low-pass) filter 230, and applies the second compensated capacitor code Q_{C-CODE} to the second/Q-baseband (low-pass) filter 232, where after the baseband filters 230 and 232 may be used for higher bandwidths.

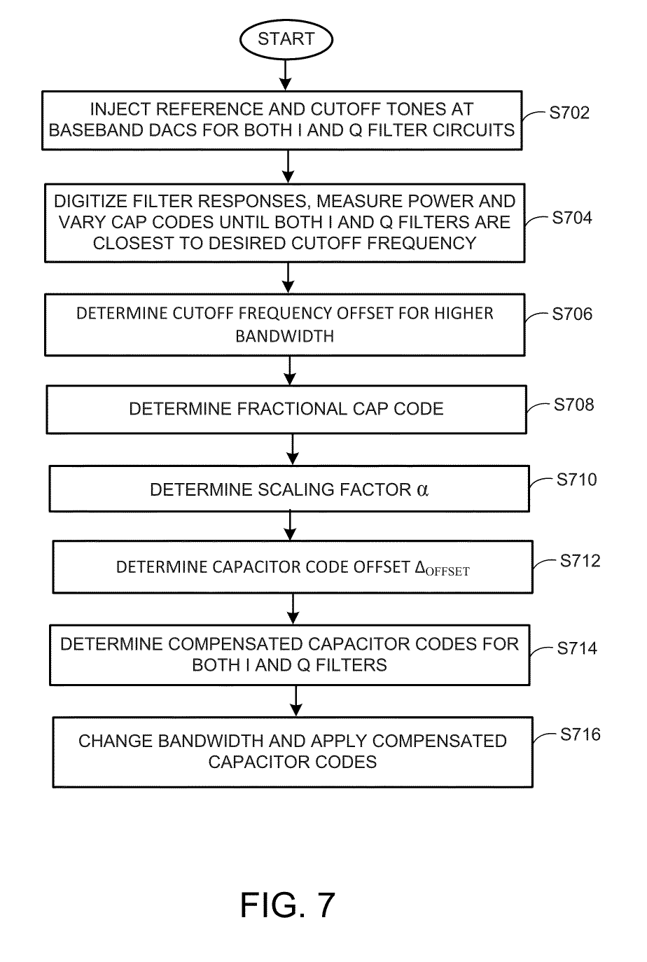

FIG. 7 is a flowchart outlining a set of example operations for providing compensating for mismatched low-pass filters, such as the I-baseband filter 230 and Q-baseband filter 232 discussed above and with respect to FIGS. 1-6. Such operations compensate for non-idealities in a filter circuit that includes programmable filter circuitry including a first low-pass filter and a second low-pass filter both having a common desired cutoff frequency f₀. It is to be appreciated to those skilled in the art in light of this disclosure that, while the various functions of FIG. 7 are shown according to a particular order for ease of explanation, that certain functions may be performed in different orders or in parallel.

At S702, for a first desired bandwidth BW₀ corresponding to the common desired cutoff frequency f₀, a reference tone f_{R} and a cutoff tone f_{C} are injected into both the first low-pass filter and the second low-pass filter using, for example, separate DACs under the control of some form of tone generation circuitry.

At S704, the responses of the first low-pass filter and the second low-pass filter are digitized using respective ADCs so as to measure power responses of the reference tone f_{R} and cutoff tone f_{C}. During this time, a capacitor code that controls a cutoff frequency f_{0-I} of the first low-pass filter is varied until a first capacitor code I_{CODE} is determined that most accurately causes the first low-pass filter to utilize the desired cutoff frequency f₀. Similarly, a capacitor code that controls the second low-pass filter is varied until a second capacitor code Q_{CODE} is determined that most accurately causes the second low-pass filter to utilize the desired cutoff frequency f₀.

At S708, a fractional capacitor code CI_{FRAC} is determined again noting that a fractional capacitor code CI_{FRAC} is a non-integer value that lies between two consecutive capacitor codes [I_{CODE}, I_{CODE+1}], and that ideally corresponds to both a zero phase difference and a zero power difference between the first low-pass filter and the second low-pass filter. While the particular methodology may vary from embodiment to embodiment, one approach to determining the fractional capacitor code C_{FRA} may be had by interpolating a line using a plurality of points with each point having (See, FIG. 5) a first dimension being a combined I-Q capacitor code [I_{CODE}, Q_{CODE}], and a second dimension being a respective measured phase offset between the first low-pass filter and the second low-pass filter using a respective combined I-Q capacitor code, then selecting a combined I-Q capacitor code value that corresponds to a substantially zero phase difference between the first low-pass filter and the second low-pass filter.

At S710, a scaling factor α is derived, for example, from empirical data. At S712, capacitor code offsets ΔI_{OFFSET} and ΔQ_{OFFSET} are determined by rounding to the nearest integer a scaled value=[(1+α Δfc) * ΔC_{FRAC}], where ΔC_{FRAC} is a difference between the fractional first capacitor code ΔC_{FRAC} and the second capacitor code Q_{CODE}, α is the scaling factor derived at S710, CI_{FRAC} is the fractional capacitor code derived at S708, and Δfc is a capacitor code difference corresponding to the cutoff frequency offset Δf determined at S706.

At S714, a first compensated capacitor code I_{C-CODE} is calculated by adding the capacitor code offset ΔI_{OFFSET} to the first capacitor code I_{CODE}. Similarly, a second compensated capacitor code Q_{C-CODE} is calculated by adding the capacitor code offset ΔQ_{OFFSET} to the second capacitor code Q_{CODE}. At S716, an operating bandwidth is changed from BW0 to BW1, the first compensated capacitor code I_{C-CODE} is applied to the first/I low-pass filter, and the second compensated capacitor code Q_{C-CODE} is applied to the second/Q low-pass filter.

While the invention has been described in conjunction with the specific embodiments thereof that are proposed as examples, it is evident that many alternatives, modifications, and variations will be apparent to those skilled in the art. Accordingly, embodiments of the invention as set forth herein are intended to be illustrative, not limiting. There are changes that may be made without departing from the scope of the invention.

What is claimed is:

1. A method for compensating for non-idealities in a filter circuit that includes programmable filter circuitry including a first low-pass filter and a second low-pass filter both having a common desired cutoff frequency f₀, the method comprising:
for a first desired bandwidth BW₀ corresponding to the common desired cutoff frequency f₀, injecting a reference tone f_{R} and a cutoff tone f_{C} into the first low-pass filter, and measuring respective filter responses of the reference tone f_{R} and the cutoff tone f_{C} while changing capacitor codes that control a cutoff frequency f_{0-I} of the first low-pass filter until a first capacitor code I_{CODE} is determined that most accurately causes the first low-pass filter to utilize the desired cutoff frequency f₀;
for the first desired bandwidth BW₀, injecting the reference tone f_{R} and the cutoff tone f_{C} into the second low-pass filter, and measuring respective filter responses of the reference tone f_{R} and the cutoff tone f_{C} while changing capacitor codes that control a cutoff frequency f_{0-Q} of the second low-pass filter until a second capacitor code Q_{CODE} is determined that most accurately causes the second low-pass filter to utilize the desired cutoff frequency f₀; and
further calibrating for mismatch between the first low-pass filter and the second low-pass filter for one or more additional bandwidths greater than the first desired bandwidth BW₀.

2. The method of claim 1, wherein the one or more additional bandwidths include a second desired bandwidth BW₁, where BW₁=N×BW₀, where N is a positive integer greater than 1.

3. The method of claim 2, wherein calibrating for mismatch between the first low-pass filter and the second low-pass filter includes:
for a respective second cutoff frequency f₁, where f₁=(N×f₀)+Δf, where Δf is a cutoff frequency offset for the second desired bandwidth BW₁:
determining a capacitor code offsets ΔI_{OFFSET} and ΔQ_{OFFSET};
adding the capacitor code offset ΔI_{OFFSET} to the first capacitor code I_{CODE} to produce a first compensated capacitor code I_{C-CODE}; and
adding the capacitor code offset ΔQ_{OFFSET} to the second capacitor code Q_{CODE} to produce a second compensated capacitor code Q_{C-CODE,} wherein the second cutoff frequency f₁=(N×f₀)+Δf, where Δf is a cutoff frequency offset for the second desired bandwidth BW₁.

4. The method of claim 3, wherein
BW₀=20 MHz, BW₁=40 MHz, f₀=8.75 MHz, f₁=18.75 MHz, and Δf=1.25 MHz; or wherein
BW₀=20 MHz, BW₁=80 MHz, f₀=8.75 MHz, f₁=38.75 MHz, and Δf=3.75 MHz.

5. The method of claim 3, wherein calibrating for mismatch between the first low-pass filter and the second low-pass filter further includes:
determining a fractional capacitor code CI_{FRAC} corresponding to the first desired bandwidth BW₀, the fractional capacitor code CI_{FRAC} being a value that lies between two consecutive capacitor codes [I_{CODE}, I_{CODE+1}], and that ideally corresponds to both a zero phase difference and a zero power difference between the first low-pass filter and the second low-pass filter; and
using the fractional capacitor code CI_{FRAC} to determine the capacitor code offsets ΔI_{OFFSET} and ΔQ_{OFFSET}.

6. The method of claim 5, wherein determining the fractional capacitor code CI_{FRAC} includes:
interpolating a line using a plurality of points with each point having a first dimension being a combined I-Q capacitor code [I_{CODE}, Q_{CODE}], and a second dimension being a respective measured phase offset between the first low-pass filter and the second low-pass filter using a respective combined I-Q capacitor code; and
selecting a combined I-Q capacitor code value that corresponds to a substantially zero phase difference between the first low-pass filter and the second low-pass filter.

7. The method of claim 5, wherein using the fractional capacitor code C_{FRAC} to determine the capacitor code offset ΔI_{OFFSET} and ΔQ_{OFFSET} includes:
rounding the fractional capacitor code CI_{FRAC} to a nearest integer to produce the capacitor code offset ΔI_{OFFSET} and ΔQ_{OFFSET};
adding the capacitor code offset ΔI_{OFFSET} to the first capacitor code I_{CODE} to produce the first compensated capacitor code I_{C-CODE}; and
adding the capacitor code offset ΔQ_{OFFSET} to the second capacitor code Q_{CODE} to produce the second compensated capacitor code Q_{C-CODE};

8. A wirelessly operating device that operates according to the method of claim 1.

9. The method of claim 7, wherein using the fractional capacitor code CI_{FRAC} to determine the capacitor code offsets ΔI_{OFFSET} and ΔQ_{OFFSET} includes:
rounding to the nearest integer a scaled value=[(1+α Δfc) * ΔC_{FRAC}] to produce the capacitor code offsets ΔI_{OFFSET} and ΔQ_{OFFSET}, where ΔC_{FRAC} is a difference between the first capacitor code CI_{FRAC} and the second capacitor code Q_{CODE}, α is a scaling factor derived from empirical data, and Δfc is a capacitor code difference corresponding to the cutoff frequency offset Δf;
adding the capacitor code offset ΔI_{OFFSET} to the first capacitor code I_{CODE} to produce the first compensated capacitor code I_{C-CODE}; and
adding the capacitor code offset ΔQ_{OFFSET} to the second capacitor code Q_{CODE} to produce the second compensated capacitor code Q_{C-CODE};

10. The method of claim 9, further comprising:
applying the first compensated capacitor code I_{C-CODE} to the first low-pass filter; and
applying the second compensated capacitor code Q_{C-CODE} to the second low-pass filter.

11. A device for compensating for non-idealities in a filter circuit that includes programmable filter circuitry including a first low-pass filter and a second low-pass filter both having a common desired cutoff frequency f₀ corresponding to a first desired bandwidth BW₀, the device comprising:
code search circuitry that controls the first low-pass filter and the second low-pass filter;
tone generation circuitry that injects a reference tone f_{R} and a cutoff tone f_{C} into both the first low-pass filter and the second low-pass filter,
measurement circuitry that: (1) measures respective filter responses of the reference tone f_{R} and the cutoff tone f_{C} while the code search circuitry changes capacitor codes that control a cutoff frequency f_{0-I} of the first low-pass filter until a first capacitor code I_{CODE} is determined that most accurately causes the first low-pass filter to utilize the desired cutoff frequency f₀; and (2) measures respective filter responses of the reference tone f_{R} and the cutoff tone f_{C} while the code search circuitry changes capacitor codes that control a cutoff frequency f_{0-Q} of the second low-pass filter until a second capacitor code Q_{CODE} is determined that most accurately causes the second low-pass filter to utilize the desired cutoff frequency f₀; and
calibration circuitry configured to calibrate for mismatch between the first low-pass filter and the second low-pass filter for one or more additional bandwidths greater than a first desired bandwidth BW₀ of the desired cutoff frequency f₀.

12. The device of claim 11, wherein each of the one or more additional bandwidths include a second desired bandwidth BW₁, where BW₁=N×BW₀, where N is a positive integer greater than 1.

13. The device of claim 12, wherein the calibration circuitry is further configured to:
for a respective second cutoff frequency f₁ for the second bandwidth BW₁, determine a capacitor code offsets ΔI_{OFFSET} and ΔQ_{OFFSET};
add the capacitor code offset ΔI_{OFFSET} to the first capacitor code I_{CODE} to produce a first compensated capacitor code I_{C-CODE}; and
add the capacitor code offset ΔQ_{OFFSET} to the second capacitor code Q_{CODE} to produce a second compensated capacitor code Q_{C-CODE};
wherein the second cutoff frequency f₁=(N×f₀)+Δf, where Δf is a cutoff frequency offset for the second desired bandwidth BW₁.

14. The device of claim 13, wherein the calibration circuitry is further configured to calibrate for mismatch between the first low-pass filter and the second low-pass filter by:
determining a fractional capacitor code CI_{FRAC} corresponding to the first desired bandwidth BW₀, the fractional capacitor code CI_{FRAC} being a value that lies between two consecutive capacitor codes [I_{CODE}, I_{CODE+1}], and that ideally corresponds to both a zero phase difference and a zero power difference between the first low-pass filter and the second low-pass filter; and
using the fractional capacitor code CI_{FRAC} to determine the capacitor code offset ΔI_{OFFSET} and ΔQ_{OFFSET}.

15. The device of claim 14, wherein the calibration circuitry is further configured to determining the fractional capacitor code CI_{FRAC} by:
interpolating a line using a plurality of points with each point having a first dimension being a combined I-Q capacitor code [I_{CODE}, Q_{CODE}], and a second dimension being a respective measured phase offset between the first low-pass filter and the second low-pass filter using a respective combined I-Q capacitor code; and
selecting a combined I-Q capacitor code value that corresponds to a substantially zero phase difference between the first low-pass filter and the second low-pass filter.

16. The device of claim 15, wherein the calibration circuitry is further configured to use the fractional capacitor code C_{FRAC} to determine the capacitor code offset Δ_{OFFSET} by:
rounding the fractional capacitor code C_{FRAC} to a nearest integer to produce the capacitor code offset Δ_{OFFSET};
adding the capacitor code offset Δ_{OFFSET} to the first capacitor code I_{CODE} to produce the first compensated capacitor code I_{C-CODE}; and
adding the capacitor code offset Δ_{OFFSET} to the second capacitor code Q_{CODE} to produce the second compensated capacitor code Q_{C-CODE};

17. The device of claim 15, wherein using the fractional capacitor code CI_{FRAC} to determine the capacitor code offsets ΔI_{OFFSET} and ΔQ_{OFFSET} includes:
rounding to the nearest integer [(1+α Δfc) * ΔC_{FRAC}] to produce the capacitor code offsets ΔI_{OFFSET} and ΔQ_{OFFSET}, where ΔC_{FRAC} is a difference between the first capacitor code CI_{FRAC} and the second capacitor code Q_{CODE}, α is a scaling factor derived from empirical data, and Δfc is a capacitor code difference corresponding to the cutoff frequency offset Δf;
adding the capacitor code offset ΔI_{OFFSET} to the first capacitor code I_{CODE} to produce the first compensated capacitor code I_{C-CODE}; and
adding the capacitor code offset ΔQ_{OFFSET} to the second capacitor code Q_{CODE} to produce the second compensated capacitor code Q_{C-CODE};

18. The device of claim 11, wherein the device is configured to:
applies the first compensated capacitor code I_{C-CODE} to the first low-pass filter; and
applies the second compensated capacitor code Q_{C-CODE} to the second low-pass filter.

19. A wirelessly operating device that incorporates the device of claim 11.
